(19) United States
(12) Patent Application Publication
(10) Pub. No.: US 2016/0021332 A1
(43) Pub. Date: Jan. 21, 2016

(54) Spatially Synchronized Video

(71) Applicant: TeleCommunication Systems, Inc., Annapolis, MD (US)

(72) Inventor: Gordon John Hines, Kirkland, WA (US)

(21) Appl. No.: 14/801,135

(22) Filed: Jul. 16, 2015

Related U.S. Application Data
(60) Provisional application No. 62/025,648, filed on Jul. 17, 2014.

(51) Int. Cl. H04N 5/92; G11B 20/10; G11B 27/32; G11B 20/00; H04N 5/77; H04N 5/935

(52) U.S. Cl. CPC H04N 5/9201; H04N 5/77; H04N 5/935; G11B 27/322; G11B 27/326; G11B 20/00007; G11B 20/10527; G11B 2020/00072

(57) ABSTRACT

A method and apparatus to spatially synchronize individual frames of a digital video recording with the spatial location of a recording camera at the time that the relevant digital video frame was recorded. The digital video is played back at a speed in relation to the rate that a playback device is traveling. The frame rate is based on movement of the recording device—frames per distance (fpd) moved. The spatially recorded digital video includes periodic position frames, with absolute or virtual position. Alternatively, position frames may be captured after a given change of distance.

The present application claims priority from U.S. Provisional No. 62/025,648, entitled “Spatially Synchronized Video”, filed Jul. 17, 2014, the entirety of which is expressly incorporated herein by reference.

### BACKGROUND OF THE INVENTION

1. Field of the Invention

This invention relates generally to digital video, and more particularly to digital video encoding and playback.

2. Background of Related Art

People record digital video in all types of situations. Digital video digitizes a sequence of images, most typically recorded at a fixed frame rate. When played back at the same fixed frame rate (if possible), the played back digital video is maintained in synch with respect to time.

Digital video cameras proliferate today, most notably in most smartphones. Many vehicles have dash-cameras—particularly law enforcement vehicles. Bikers have helmet cameras. Walkers record while walking. Google Glass, and technology of similar ilk, can also record digital video, all typically at a fixed frame per second, or frame rates that are synched with time.

In operation, conventional digital video data is recorded and played back time-synched. Digital video is generally recorded at a number of frames per seconds. This is referred to as frame rate, also known as frame frequency. The frame rate is the rate at which a recording device records, and displays, consecutive images or frames. Frame rate is conventionally expressed in frames per second (fps).

There are many conventional formats for digital video, of different resolution, including CGA, QVGA, VGA, NTSC, PAL, WVGA, SVGA, WSVGA, XGA, HD 720, WXGA, SXGA, SXGA+, WSXGA+, UGA, HD 1080, 2K, WUXGA, QXGA, WQXGA and QSXGA.

All conventional digital video formats have an image frame rate, which is the frequency at which a digital image is captured and recorded. Conventional frame rates include 24 frames per second, 25 frames per second, and 30 frames per second. Higher frame rates may be used in high definition television (HDTV) type applications, e.g., 50 or 60 frames per second. Conventional frame rates go as high as 90, 144, 240 and even 300 frames per second (fps).

FIG. 3 shows a conventional digital video including a set of video frames recorded at a particular rate.

In particular, as shown in FIG. 3, individual images 110, 111, . . . 197-199, e.g., at an HD 1080 resolution of 1920×1080 pixels, are captured and recorded in sequence over time t into a digital video recording 100

FIG. 4 shows the conventional time synchronized playback of digital video, including digital video frames played back at the same rate as what they were recorded at.

In particular, as shown in FIG. 4, previously recorded individual images 110, 111, . . . 197-199 are played back in time-synch with the original recording frame rate (number of image frames per second). Of course, the individual images 110, 111, . . . 197-199 may instead be played back at a fraction of the original frame rate, resulting in a slow motion playback with respect to the timing of the original recording. Similarly, the individual images 110, 111, . . . 197-199 may instead be played back at a multiple of the original frame rate, resulting in a fast motion playback with respect to the timing of the original recording.

When a conventional video stream is played back at the same frame rate that it was recorded at, the played back video is referred to herein as “time synched” with the recording of the same video, meaning that the timing of the played back digital video matches the timing of the recording of the same digital video.

Video playback attempts to display each frame at the frames per second rate if it can, but if it cannot, it will drop frames. The important component is that the digital video stays time synched.

Thus, when a conventional digital video stream or clip is played back at the same frame rate that it was recorded at, you see what the user of the recording device saw, over the same length of time (i.e., the same speed) that the user of the recording device saw. Thus, the digital video is typically played back “in synch” with the time of the original recording. Of course, a digital video may be played back at a proportional fraction of the synched time (i.e., resulting in an appearance of the lengthening of the time, or slow motion), or a multiple of the synched time (i.e., resulting in an appearance of the shortening of the time, or fast forward motion).

U.S. Pat. No. 8,717,254 to a Portable Motion Sensor and Video Glasses System for Displaying a Real Time Video Display to a User While Exercising discloses recording video at one speed, then playing it back at a speed that varies depending on the speed of the person exercising (and watching the recorded video on video glasses; see for example column 5, lines 56 to column 6 lines 18; Col. 7 line 17 to col, 8, line 35).

To envision where a particular digital video was recorded, one might caption a posting of the video to, e.g., a social media website. Or, one might infer a location from the subject matter and other imagery contained within the digital video, e.g., a video of the statute of liberty infers that the location that the video was taken was manhattan.

WO2007065171 to a Self Contained Automatic Multi-Sensor Encoding for Cameras and Images appears to disclose automatic encoding of sensor data in a video image, including location, time, heading and velocity (LTHV). On page 5 various applications are listed that could make use of embedded LTHV encoding for a location search, including automotive and handheld tour displays and wireless display devices (depicting images or routes by location).

US Publ. No. 2005/0108261 to Geodigital Multimedia Data Processing System and Method was cited in a PCT patentability opinion against WO2007065171, and discloses details about how certain sensor data could be associated with certain image data (see paragraph 38), including associating different security levels with metadata (see paragraphs 34, 41 and 52.) Why you would want to embed metadata in images/video is addressed in paragraphs 65-67.

Geocode-LA, Inc. offered a patent license containing a claim that appears to convert geocoordinates from DMS format to decimal format. Other claims appear to claim a video processing system that embeds video capture meta data (direction, focal length, location) at the capture device and process the information before forwarding the video on.

While attempts have been made to associate a location with digital video, if the digital recorder is moving, the inventor has realized that such conventional location generally indicates a static, objective location where a digital video was recorded.

### SUMMARY OF THE INVENTION

In accordance with the principles of a first aspect of the present invention, a method of recording a spatially-synched video, comprises capturing a first image of a given resolution, and encoding the first image into a spatially-synched video recording. A current location of a recording device recording the spatially-synched video is encoded into a first position frame in the spatially-synched video. The recording device waits until it has moved a distance d, and then it captures a second image of the resolution, and encodes the second image into the spatially-synched video recording.

In accordance with another aspect of the present invention, a method of encoding position frames into a digital video recording comprises encoding a first plurality of spatially-synched captured image frames into a digital video recording. A first heading of a physical recording device recording the digital video recording when capturing a last of the first plurality of spatially-synched captured image frames, is encoded into a first position frame in the digital video recording. A second plurality of spatially-synched captured image frames are encoded into the digital video recording, and a second heading of the physical recording device recording the digital video recording when capturing a last of the second plurality of spatially-synched captured image frames, is encoded into a second position frame in the digital video recording.

In accordance with yet another aspect of the present invention, a method of playing back a spatially-synched video comprises displaying a first image of a given resolution decoded from a digital video recording. The playback device determines that it has moved a distance d, then it displays a second image of the given resolution decoded from the digital video recording. The playback device then determines that it has again moved another distance d, and then it displays a third image of the given resolution decoded from the digital video recording.

### BRIEF DESCRIPTION OF THE DRAWINGS

Features and advantages of the present invention become apparent to those skilled in the art from the following description with reference to the drawings, in which:

FIG. 1 shows a spatially encoded digital video including a sequence of spatially synchronized digital video frames recorded at a rate corresponding to a distance of movement of a recording device (frames per distance), with geographical position information periodically encoded in position frames, in accordance with the principles of the present invention.

FIG. 2 shows playback of a spatially encoded digital video including a sequence of spatially synchronized digital video frames played back at a rate based on a movement (distance traveled) of the playback device, in accordance with the principles of the present invention.

FIG. 3 shows a conventional digital video including a set of video frames recorded at a particular rate.

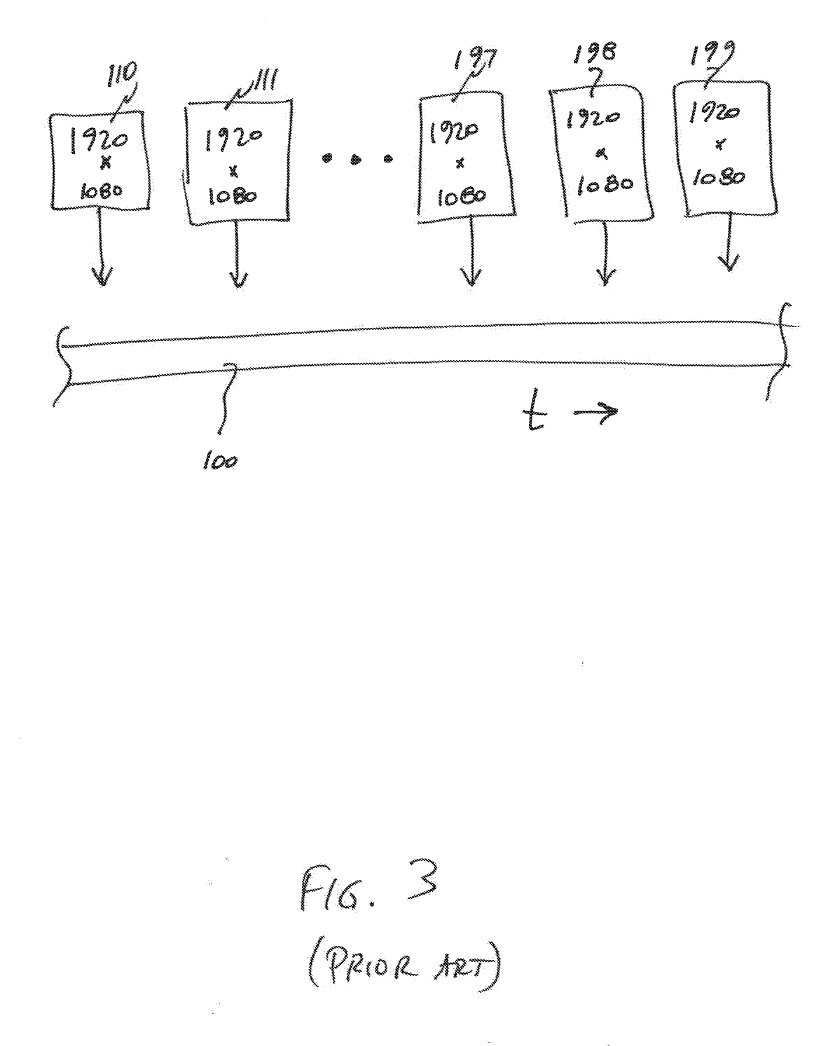

FIG. 4 shows the conventional time synchronized playback of digital video, including digital video frames played back at the same rate as what they were recorded at.

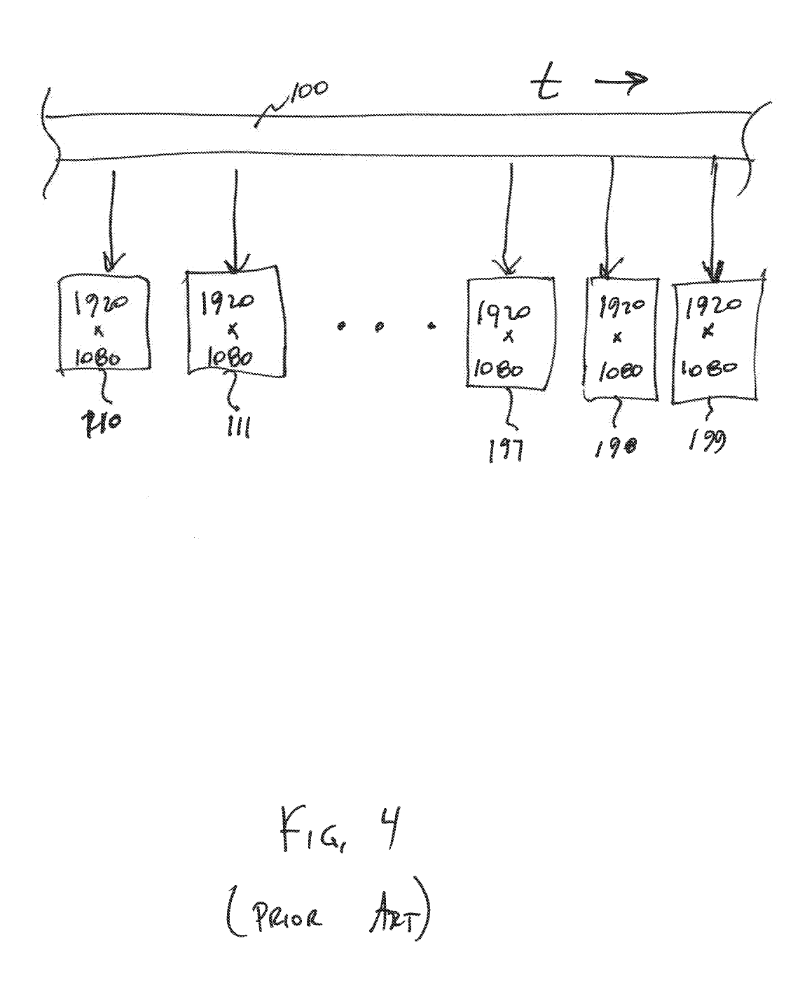

### DETAILED DESCRIPTION OF ILLUSTRATIVE EMBODIMENTS

The present invention provides a method for encoding subjective location into a digital video. In other words, the invention provides a method of encoding the ‘trip’ that the recording device took while it recorded all frames of a given digital video. The trip may comprise only distance information, or it may include both distance and heading.

While conventional digital video techniques, at best, tell you the city or place that a given digital video was recorded, the present invention provides digital video that is recorded not on a time base, but instead on a distance traveled base. The digital video may include additional position frames including information about the location (position) and heading of the recording device periodically included between captured digital frames, for the duration of the digital video.

The present invention provides a fundamental shift in digital video encoding and playback technology to permit spatial—as opposed to time—synched video. The present invention provides a method and apparatus to synchronize individual frames of a digital video recording with the spatial location of the camera at the time that the relevant digital video frame was recorded. In this way, a digital video may be played back, e.g., at a speed in relation to the rate that a playback device is traveling.

Imagine a vehicle recording a disaster area as it drives through the area. Thereafter, as field personnel go over the same path taken by that vehicle, the digital video recorded and encoded in accordance with the present invention permits synchronized playback of the digital video, frame by frame as it relates to the position of the playback device matching the location of the recording device as it recorded relevant digital video frames. In this way, a digital video recording may be played back and viewed in synch with position as you walk through the area.

Thus, the invention enables synchronization of recorded digital video to position, and displays individual digital video frames not at a fixed data rate, or fixed rate with respect to the timing of the recording, but rather based on the viewer's position.

The present invention introduces a frame rate based on movement of the recording device as it is recording the sequential image frames that make up a video clip—frames per distance (fpd) moved. The specific distance may be any suitable measurement, e.g., frames per inch movement of the recording device (fpi), frames per foot movement of the recording device (fpf), frames per meter (fpm), etc.

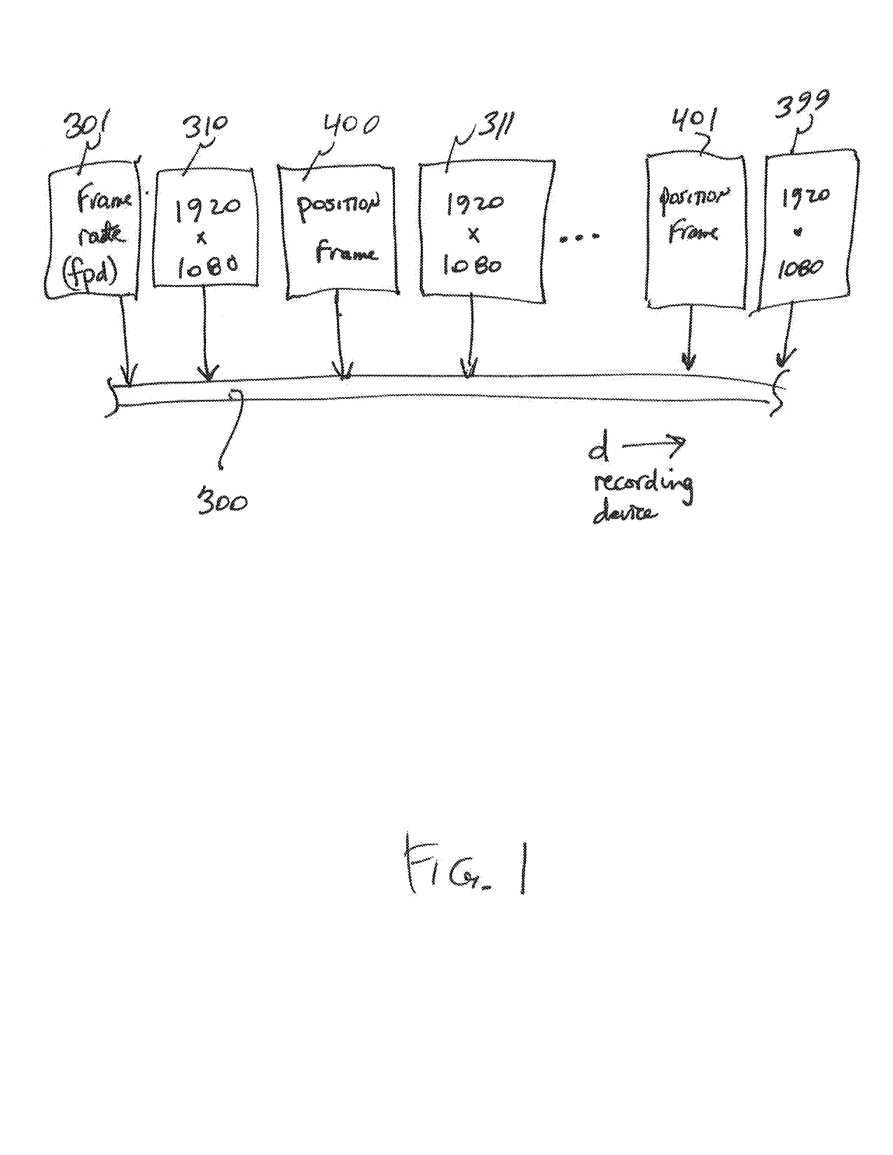

FIG. 1 shows a spatially encoded digital video including a sequence of spatially synchronized digital video frames recorded at a rate corresponding to a distance of movement of a recording device (frames per distance), with geographical position information periodically encoded in position frames, in accordance with the principles of the present invention.

In particular, as shown in FIG. 1, a digital video recording 300 includes a sequence of captured images 310, 311, . . . 399, at a resolution appropriate for the given digital video standard (e.g., HD 1080). The present invention is applicable to any digital video standard that captures and records a sequence of digital images.

The inventor herein refers to the distance-based (not time-based) frames of the inventive spatially synchronized video as being “spatiodic”. Spatiodic, as defined by the present inventor, is the reoccurrence of something based on distance interval. For instance, after moving 1 meter then record a video frame. This differs from “periodic” that is generally defined as an reoccurrence of something based on time interval.

In accordance with the principles of the present invention, the captured images 310, 311, . . . 399 aren't recorded on a time base as in conventional digital video, but instead recorded on a distance d traveled base, distance referring to the distance traveled by the recording device between captured image frames 310, 311.

The distance d between captured image frames 310, 311, . . . 399 may be set to any appropriate value based on the application. The spatially recorded digital video in accordance with the principles of the present invention may further include periodic position frames 400, 401. The position frames 400, 401 may include position information of the recording device, either absolute geographic location of the recording device when it recorded the previous captured image frame 310, or a relative location with respect to a previous position frame.

If the spatial frame rate is a standard, or otherwise known, then there is no need to include a spatial frame rate (fpd) encoded within the digital video 300. But if the spatial frame rate (fpd) may vary, then it is preferred that a spatial frame rate (fpd) frame 301 be encoded in the digital video 300.

In the recording of the digital video 300, in alternative embodiments, rather than encoding position-frames periodically, position frames are captured after a given change of distance. In this way, instead of frames per second (fps), digital video is captured at frames per distance (fpd).

Distance based recording is best for applications where the recording device is moving. If the digital video recording device were not to move at all, only one frame of digital video would be encoded. When the recording device moves, subsequent digital video frames are then encoded for each given change in distance (depending upon the given fpd rate).

The encoded distance may be in any suitable measure of distance, e.g. meter, kilometer, foot, inch, etc. The encoded distance between digital video frames may also be proportional to speed of the recording device.

The position frame may be an absolute geographic location on the earth, or a relative location with respect to a starting point of the digital video.

The specific location of the recording device while capturing periodic frames of a given digital video are recorded and encoded in a position frame. Upon playback, the specific location for any captured image, e.g., 311, may be interpolated from the locations recorded in successive position frames 400, 401 within the digital video.

‘Position frames’ 400, 401 are encoded within the digital video stream 300 such that a spatial location of the recording device when recording a given frame of digital video (e.g., 310) is recorded by the recording device when the relevant image frame is recorded.

Not all image frames need include an associated position frame 400, 401, and indeed such intensive location fixing (e.g., 30 times a second) would both burden a communications network as well as yield little if any movement between successive image frames. Rather, a periodic inclusion of a position frame 400, 401 within the digital video 300 is sufficient, and may be adjusted based on the application. For instance, if a video is made from an aircraft a position frame 400, 401 may be desirable at least once per second (e.g., every 30 image frames), and indeed even more frequently may be desirable in such a highspeed application. On the other hand, video recording in a law enforcement officer's body cam might warrant a position frame periodicity of, e.g., once every 3 seconds, or once every 5 seconds, etc.

Thus, the invention provides, rather than (or in addition to) encoding time based frame rates, or time at specific key frames, position (latitude, longitude, attitude or any other real-world coordinate system or a delta distance (or distance traveled to this point)), speed and heading are encoded within the digital video recording.

For the purposes of this invention disclosure, the encoded position and/or speed and/or heading is called a ‘Position Frame’. Not all location-related components need be present in a position frame.

For instance, just position of the recording device can be encoded and included within the digital video recording as a position frame.

Alternatively just speed can be encoded and included within the digital video recording as a position frame.

Alternatively just position+heading can be encoded and included within the digital video recording as a position frame.

Alternatively just speed+heading can be encoded and included within the digital video recording as a position frame.

Alternatively, just position+speed can be encoded and included within the digital video recording as a position frame, etc.

Heading provides direction so that a viewer knows (via playback device) which direction a given digital video was shot from.

In practice (depending on the digital video format utilized), the ‘Position Frame’ may be a separate frame like an image key-frame, or a time synch frame, or the position frame can be formed by location attributes included with a given digital video frame.

Not all digital video frames need be encoded with an associated position frame. Most GPS and other location techniques do not typically provide location with sufficient frequency to enable encoding every digital video frame within a digital video (e.g., 30 frames per second, 12 frames per second, etc.) Depending upon the application, and speed of the recording device, periodic encoding of position frames within a given digital video are preferred. The periodicity of the encoded position frames may be determined based on the particular application and speed of the recording device.

For efficiency, position frames may be included for each significant heading or speed change. Thus, besides periodically encoding a position frame, each significant heading or speed change preferably triggers encoding of a position frame.

Moreover, for better/easier playback, each position frame preferably should be accompanied with traditional timing information, and/or preferably a number of digital video frames (or time) since the last position frame.

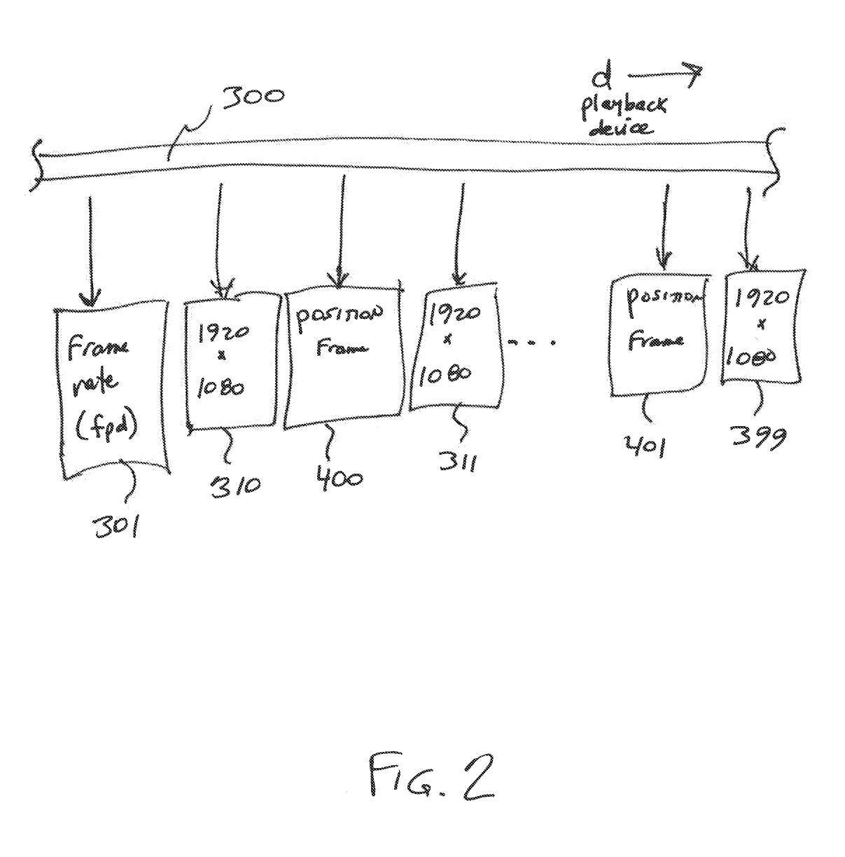

FIG. 2 shows playback of a spatially encoded digital video including a sequence of spatially synchronized digital video frames played back at a rate based on a movement (distance traveled) of the playback device, in accordance with the principles of the present invention.

In particular, as shown in FIG. 2, the captured digital images 310, 311, . . . 399 are played back in sequence, but at a rate corresponding to a distance traveled by the playback device. If the physical playback device travels at the same speed as the recording device did while recording the digital video 300, then the playback video will play at the same rate as when recorded. If the playback device travels at a rate slower than the recording device did when recording the digital video 300, then the playback video will play at a slower rate than as recorded. If the playback device travels at a rate faster than the recording device did when recording the digital video 300, then the playback video will play at a faster rate than as recorded. If the playback device is not moving, then the digital video will remain on a single captured frame.

Movement of the playback device may be emulated on a personal computer or laptop, e.g., with a mouse curser movement, or finger gesture on a touch screen, along a mapped route.

This invention spatially synchronizes the digital video to coordinates. Alternatively, the invention permits synchronization at an all together different location by instead to a relative distance moved. Or, including the full special capabilities of the present invention, playback of a digital video encoded per the present invention may be played back based on relative location movement, including distance and direction.

What this invention provides is that digital video that was recorded at one rate and spatially keyed, can be played back at another rate based on spatial movement (real or virtual) of a viewing digital video device (e.g., a smart phone).

In addition to spatially synchronized playback of digital video based on a playback device moving across the near absolute locations where individual frames of a spatially encoded digital video were recorded, the present invention also relates to virtual positioning for spatially synchronized playback of a spatially encoded digital video. In particular, the playback device may start from a different physical position, but the spatially synchronized video is played back based on a heading and rate of change of movement of the playback device corresponding to the spatial encoding within the digital video being played back.

For instance, if a digital video is recorded at a high frame rate while traveling at high speed, when a viewer is watching the digital video and traveling at a slower speed, the playback frame rate will drop proportionately so that what the recorder saw at a particular location, is what the viewer will see at the same location even if they are traveling at a different speed, such that the digital video playback is spatially synchronized with the original recording.

One interesting aspect of the implementation of spatial recording in frames per distance is that if a full position frame is captured at the start (including position and heading), because the digital video is distance based, subsequent position frames only need to encode heading. Playback of the fpd digital video is able to determine the spatial position of each digital video frame encoded with a key-frame/position frame.

The spatial position of intermediate digital video frames between position frames may be interpolated.

Traditional digital video playback is time-synched and plays at the highest frame rate possible (not exceeding the recorded frame rate) to keep the digital video and audio in time-synch. This is very important for audio because if the audio was played slower or faster the audio would not sound as intended. For pure digital video (without audio) if the digital video runs slightly faster or slower there is not much visual difference.

With spatially synched digital video, the playback frame rate is dependent on the viewer's spatial rate of change (not time-synched). If digital video is recorded at 60 frames per second, at 30 miles per hour, a viewer traveling at 60 miles per hour would see the playback twice as fast, and a viewer traveling at 3 miles per hour would see the playback 10 times slower.

The present invention relates to distance synchronization of video—not distance over time such as rate, speed, velocity, etc., which are distance over time (d/t). The present invention relates to frames per distance without synchronization to time.

During playback, the decoder gets the current position-frame and retrieves the next position-frame. Using the position frames, it can be determined over what distance the encompassing digital video frames were captured over. The digital video player uses this information and then shows the digital video frame synched to the viewer's position (estimating the position of the digital video frame).

As the fpd digital video playback device moves forward and backwards, the frames of the played digital video too preferably moves forward and backwards, respectively.

Embodiments herein require a recording device capable of location. The location is preferably determined locally, e.g., via a GPS chipset, but may alternatively be determined and provided by a location services server or other network system.

Video playback of fpd digital video need not be tied to the physical world. As an example, the fpd digital video may be displayed on a web-page or in a mobile application together with a map. The spatial route that the capturing device took while recording the fpd digital video may be deciphered from the digital video and displayed on the map. The digital video playback device may follow the same route using a computer input such as a mouse, a stylus, gesturing of a finger (or fingers) on a touch screen, etc. to indicate traversal of a route on the map, with a digital video window playing back the fpd digital video in synch to the position represented on the map.

Some of the disclosed embodiments relate to ‘position-frames’ encoded in a spatially-synched digital video recorded in frames per distance (fpd) format (e.g., frames per meter). The disclosed embodiments further relate to how to play back time-synched digital video or spatially-synchronized digital video based on the position of the playback device.

Moreover, while some of the disclosed embodiments relate to a playback device's position being absolute (i.e., following the actual path of the recording device for playback), the playback device's position can be offset to relative movement along a similar route or path in a different part of the world, with the same distance, heading, speed, etc., to create a virtual position.

The present invention is useful, e.g., for virtual tours. For instance, a reference digital video of a certain area as it looks now may be recorded in a frames per distance (fpd) format. Thereafter, a spatially synchronized playback device may playback the fpd digital video, e.g., after a natural disaster; after a civic modification or construction is built; after many years of time; etc. This enables the playback of spatially recorded fpd digital video may be played back, spatially synched to current real (or virtual or relative) movement through the same area many years later.

The present invention also has particular applicability in combination with 360 panoramic movies. (E.g., GoPano is an example of a 360 degree movie where the viewer can change their viewing perspective.) A set of 360 panoramic movies of a given spatial route that crisscrosses and uses spatial synching can form a new multi-dimensional walk around viewing experience.

While the invention has been described with reference to the exemplary embodiments thereof, those skilled in the art will be able to make various modifications to the described embodiments of the invention without departing from the true spirit and scope of the invention.

What is claimed is:

1. A method of recording a spatially-synched video, comprising:
capturing a first image of a given resolution;
encoding said first image into a spatially-synched video recording;
encoding a current location of a recording device recording said spatially-synched video, into a first position frame in said spatially-synched video.
determining that said recording device has moved a distance d, and then capturing a second image of said resolution;
encoding said second image into said spatially-synched video recording.

2. The method of recording a spatially-synched video according to claim 1, further comprising:
periodically encoding each of a plurality of additional position frames in said spatially-synched video, intermixed with a plurality of additional captured images of said given resolution.

3. The method of recording a spatially-synched video according to claim 1, wherein:
said current location is a unique geographic coordinate.

4. The method of recording a spatially-synched video according to claim 1, wherein:
said current location is a relative starting point of movement of said recording device.

5. The method of recording a spatially-synched video according to claim 1, wherein:
said recording device is a phone.

6. The method of recording a spatially-synched video according to claim 1, further comprising:
encoding a starting location in a position frame including a starting location of said spatially-synched video.

7. The method of recording a spatially-synched video according to claim 1, wherein:
said given resolution is 1920 pixels×1080 pixels.

8. The method of recording a spatially-synched video according to claim 1, further comprising:
encoding a frame rate in frames per distance (fpd) in said spatially-synched video.

9. The method of recording a spatially-synched video according to claim 1, wherein:
said distance d traveled by said recording device is a fixed value between each of a plurality of successive captured images.

10. The method of recording a spatially-synched video according to claim 1, further comprising:
encoding a frames per distance (fpd) frame rate into said digital video recording.

11. The method of recording a spatially-synched video according to claim 10, wherein:
said distance is inches.

12. The method of recording a spatially-synched video according to claim 10, wherein:
said distance is feet.

13. The method of recording a spatially-synched video according to claim 10, wherein:
said distance is meters.

14. A method of encoding position frames into a digital video recording, comprising:
encoding a first plurality of spatially-synched captured image frames into a digital video recording;
encoding a first heading of a physical recording device recording said digital video recording when capturing a last of said first plurality of spatially-synched captured image frames, into a first position frame in said digital video recording;
encoding a second plurality of spatially-synched captured image frames into said digital video recording; and
encoding a second heading of said physical recording device recording said digital video recording when capturing a last of said second plurality of spatially-synched captured image frames, into a second position frame in said digital video recording.

15. The method of encoding position frames into a digital video recording according to claim 14, wherein:
said first position frame includes first location information of said physical recording device when capturing said last of said first plurality of spatially-synched captured image frames; and
said second position frame includes second location information of said physical recording device when capturing said last of said second plurality of spatially-synched captured image frames.

16. The method of encoding position frames into a digital video recording according to claim 15, wherein said first location and said second location each comprise:
a geographic coordinate.

17. The method of encoding position frames into a digital video recording according to claim 15, wherein said second location comprises:
a relative position with respect to said first location.

18. A method of playing back a spatially-synched video, comprising:
displaying a first image of a given resolution decoded from a digital video recording;
determining that a playback device has moved a distance d, and then
displaying a second image of said given resolution decoded from said digital video recording;
determining that said playback device has moved another distance d, and then
displaying a third image of said given resolution decoded from said digital video recording.

19. The method of playing back a spatially-synched video according to claim 18, comprising:
periodically decoding each of a plurality of position frames from said spatially-synched video, intermixed with display of a plurality of additional images of said given resolution decoded from said digital video recording;
wherein said plurality of position frames each include a heading of said playback device.

20. The method of playing back a spatially-synched video according to claim 19, wherein said plurality of position frames each include:
a current geographic location of said playback device.
